(19) United States
(12) Patent Application Publication
(10) Pub. No.: US 2014/0365634 A1
(43) Pub. Date: Dec. 11, 2014

(54) Programmable Network Analytics Processing via an Inspect/Apply-Action Applied to Physical and Virtual Entities

(71) Applicant: Cisco Technology, Inc., San Jose, CA (US)

(72) Inventors: Christopher Metz, Danville, CA (US); David Ward, Los Gatos, CA (US); Jan Medved, San Jose, CA (US); Reinaldo Penno, Milpitas, CA (US); Luyuan Fang, Holmdel, NJ (US); Jisu Bhattacharya, San Jose, CA (US)

(21) Appl. No.: 13/910,177

(22) Filed: Jun. 5, 2013

(51) Int. Cl. H04L 12/24

(52) U.S. Cl. CPC H04L 41/14
USPC 709/224

(57) ABSTRACT

Techniques are provided to programming network analytics processing in virtual and physical network devices, useful for software-defined networking (SDN). A controller, e.g., a so-called SDN controller, is configured to identify a control-plane or data-plane flow originating, terminating or transiting a physical or virtual network element. The controller generates one or more network analytics processing actions to be performed by the physical or virtual network element based on inspection of traffic by the physical or virtual network element. The controller forms or generates an inspect/apply-action message containing information identifying the control-plane or data-plane flow for inspection and the one or more network analytics processing actions to be performed. The inspect/apply-action message is sent to the physical or virtual network element.

### TECHNICAL FIELD

The present disclosure relates to computer networks and more particularly to Software Defined Networking.

### BACKGROUND

Network operators are becoming increasingly interested in extracting network analytics information from physical or virtual instances of network devices. Network analytics information can be in the form of NetFlow or Internet Protocol Information Export (IPFIX) records which contains information on traffic flows traversing the physical or virtual network element. Examining and recording information about the application payload may yield another form of network analytics information useful to an operator.

Provisioning network analytics processing in a large network requires manual configuration on potentially each interface of each physical or virtual network element. Additional manual configuration to select and perform network analytics processing for a subset of traffic would also be required. In cases where targeted network analytics processing needs to be quickly invoked, the delay in manual operator configuration could impact the overall health of the network.

The problem of manual configuration is exacerbated by the industry's move towards network virtualization. A potentially very large number of discrete virtual networks are overlayed onto a physical network infrastructure. Each virtual network could be composed of hundreds, thousands or tens of thousands of virtual elements, where an element can be a virtualized instance of a switch, router, appliance or host. These virtual elements can even be software instances of certain network functions residing within network or computing devices. The number of these virtual element instances can be very large. The location of these virtual elements may change rapidly. Therefore, manual configuration of potentially hundreds or thousands of theses virtual elements is not practical, if not impossible.

### BRIEF DESCRIPTION OF THE DRAWINGS

FIG. 1A is a block diagram of a system in which the programmable network analytics processing techniques presented herein may be employed.

FIG. 1B is a block diagram of a system showing an implementation of numerous virtual network elements in a data center and in which the programmable network analytics processing techniques presented herein may be employed.

FIG. 2 is a diagram generally illustrating the flow of operations associated with the programmable network analytics processing techniques.

FIG. 3 is a flow chart depicting operations performs in a network analytics processing controller.

FIG. 4 is a flow chart depicting operations performed in a physical or virtual network element.

FIG. 5 is an example block diagram of a physical or virtual network element configured to perform the operations presented herein.

FIG. 6 is an example block diagram of a network analytics processing controller configured to perform the operations presented herein.

### DESCRIPTION OF EXAMPLE EMBODIMENTS

### Overview

An architecture and related methods are provided for programming network analytics processing in virtual and physical network devices, useful for Software Defined Networking (SDN). A controller, e.g., a so-called SDN controller, is configured to identify a control-plane or data-plane flow originating, terminating or transiting a physical or virtual network element. The controller generates one or more network analytics processing actions to be performed by the physical or virtual network element based on inspection of traffic by the physical or virtual network element. The controller forms or generates an inspect/apply-action message containing information identifying the control-plane or data-plane flow for inspection and the one or more network analytics processing actions to be performed. The inspect/apply-action message is sent to the physical or virtual network element. The physical or virtual network element receives the inspect/apply-action message, and inspects network traffic originating, terminating or transiting the physical or virtual network element in accordance with information contained in the inspect/apply-action message. The physical or virtual network element performs an action for traffic that satisfies the information contained in the inspect/apply-action message.

### Example Embodiments

An underlying paradigm in Software Defined Networking (SDN) is the programmatic control of physical or virtual packet switching devices via Inspect/Apply-Action Application Programming Interfaces (APIs). This API allows an application to program the packet processing rules in the physical or virtual device. Each rule contains a list of Inspect (classification) rules that identify a packet stream (or flow) and a list of one (or more) Apply actions that the physical or virtual packet switching device will execute upon receipt of the identified packet stream. The Inspect rules may include simple Internet Protocol (IP)-tuple matches, L2/L3 10-tuple matches, or application-defined signatures that define match criteria not only for packet header fields, but also for the packet payload. An Apply-Action typically involves a forwarding action such as switching the packets of the stream to an outbound port but may also include some form of packet manipulation (e.g. changing a field in the packet header) or setting of Quality of Service (QoS).

Current network analytics processing requires manual configuration. Targeted analytics processing requires additional manual configuration, may take too long and there is the possibility of error. Network virtualization makes the problem even more difficult to solve, as there can be a very large number of virtual network elements. In addition, virtual instances of these elements may move from one location to another very rapidly.

The typical SDN Inspect/Apply-Action designates a forwarding (data-plane) behavior that is programmatically installed on a physical network device (e.g., packet switching or routing device). The system configuration presented herein is different in that it extends the SDN Inspect/Apply-Action to physical or virtual elements (hosts or packet switching entities) to in turn:
a) identify a control or data-plane flow originating, terminating or transiting the physical or virtual element; and
b) specify one or more Network Analytics Processing (NAP) actions that will be performed by the physical or virtual element based on inspection of the identified traffic.
   Together a) and b) form a Network Analytics Processing Inspect/Apply-Action construct (message).

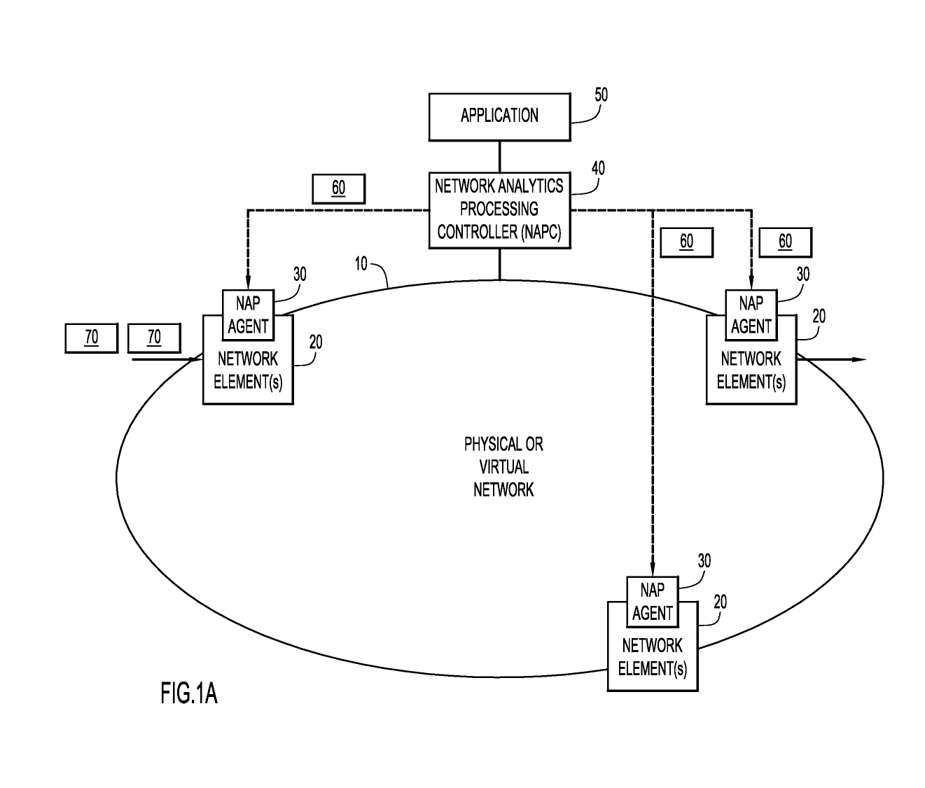

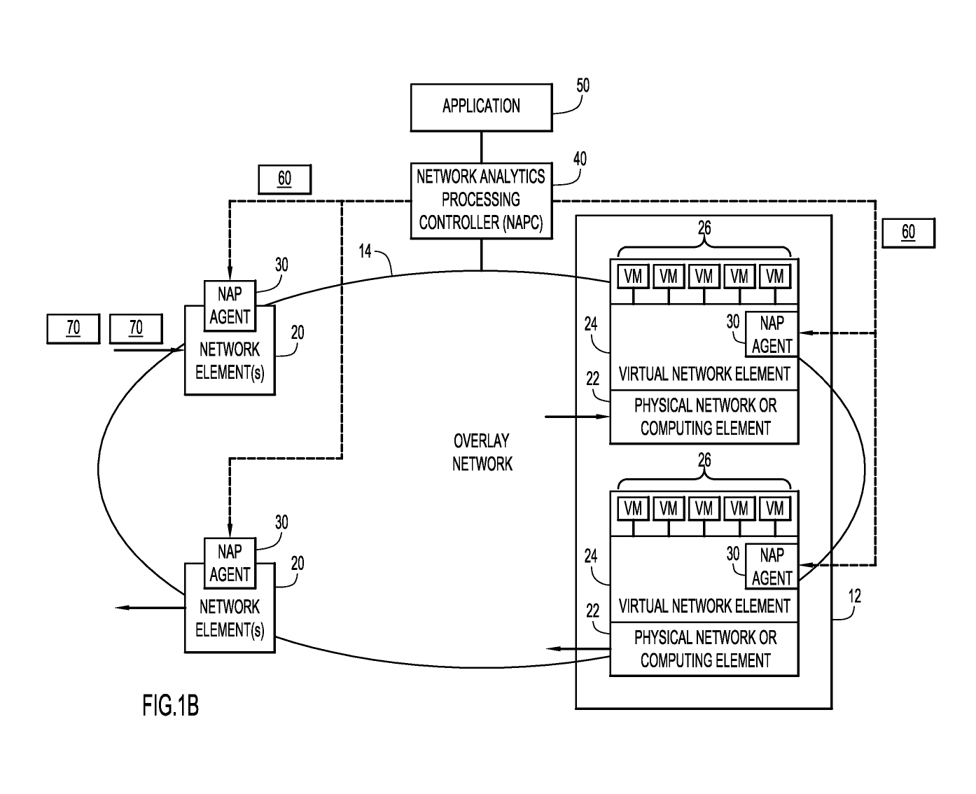

Referring to FIG. 1A, a diagram is shown in which a physical or virtual network 10 is deployed and there are a plurality of network elements 20 each having installed therein or configured with a NAP agent 30. There is a Network Analytics Processing Controller (NAPC) 40. The role of the NAPC is to communicate NAP Inspect/Apply-Action messages 60 to one or more physical or virtual elements, i.e., one or more network elements 20. The NAPC 40 generates the NAP Inspect/Apply-Action messages in accordance with commands it receives from an application 50.

The NAP agent 30 resides on the physical or virtual elements 20 and is responsible for parsing the NAP Inspect/Apply-Action message 60 received from the NAPC 40 and applying the message contents to actions on which the physical or virtual element can act, e.g., based on data packets 70 that flow through the network elements 20.

FIG. 1B is an abstract illustration of virtual elements (virtual routers/switches) residing in a data center 12 as part of an overlay network 14. The data center 12 includes a plurality of physical network or computing elements 22 (e.g., server blades or processing cores) that run a virtual network element 24 and associated one or more application Virtual Machines (VMs) 26. The virtual network elements 24 can take actions on data packets 70 based on NAP Inspect/Apply-Action messages 60 from the NACP 40. These virtual elements can be thousands in numbers in a single data center. The application VMs 26 may include virtual provider edge (vPE) routers that serve as virtual customer edge (CE) devices and are mobile in the sense that they can be activated/de-activated and moved around in the data center much more dynamically than a typical customer edge connection to a physical provider edge. For example, virtual elements are more dynamic; they can be powered up/down along with the physical devices (servers) much more frequently than physical router/switches.

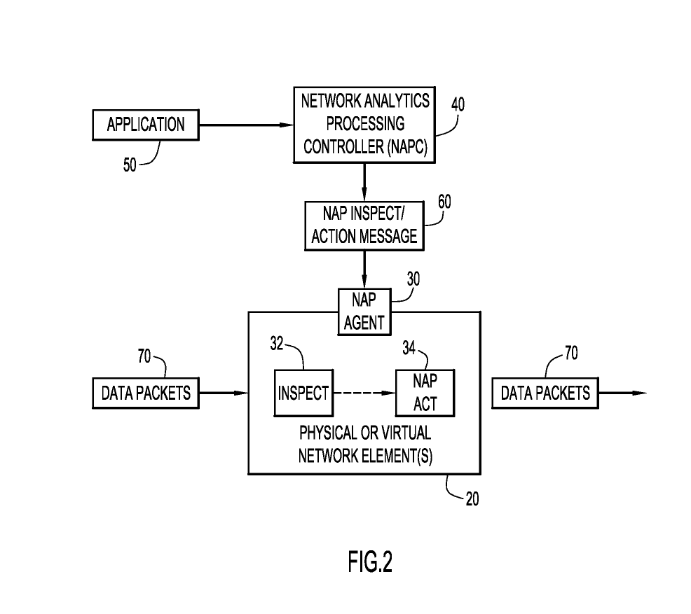

Turning now to FIG. 2, a further description is provided for the operations of the NAPC 40 and NAP agent 30. Data packets 70 are forwarded through a network of one or more physical or virtual network elements (i.e. routers, switches, appliances, etc.). An application 50 or a human operator interfaces to the NAPC 40 requesting a NAP action to be performed for certain data packets flows in the network. The NAPC 40 converts the NAP action request to specific NAP Inspect/Apply-Actions to be performed on network elements in the network, generates NAP Inspect/Apply-Action messages and sends the NAP Inspect/Apply-Action messages to NAP agents 30 associated with physical/virtual network elements 20.

The NAP agent 30 receives the NAP Inspect/Apply-Action message 60, parses it and installs Inspect function 32 and NAP action function 34 in network element(s) 20. Data packets 70 passing thru, originating from or terminating in a network element 20 are inspected according to the Inspect function 32. If a MATCH is found (e.g., based on a tuple of information in the packet flow), then one or more network analytics processing functions are performed according to the NAP action 34. In all cases, the data packets 70 continue to be forwarded by the network element.

In one example application of these techniques, consider a network operations center (NOC) that is responsible for managing a large cloud network composed of virtual and physical network elements. A problem is detected in one of the virtual networks requiring the operator to rapidly re-configure several hundred virtual elements (a mix of virtual hosts and virtual switches) to activate a NAP action involving inspection of Transport Control Protocol (TCP) flows sourced by customer X. The results of the inspection should be sent to a special server located at server Y.

The NAPC can immediately handle this process by transmitting the following message to each NAP agent running in each of the virtual network elements:

NAP Inspect/Apply-Action:
Inspect <source=customer X; traffic flow=TCP>
Apply-Action <Inspect; send inspection results=server Y>

The NAP agent 30 contained in each of the virtual network elements receives the message. It then ensures that the virtual network element executes the desired behavior or action.

In another example, the NAPC 40 can be tied into a customer service database so that when customer packets arrive on the network, the NAPC 40 can signal one or more physical or virtual elements to generate network analytics information based on the customer traffic.

Other example use cases include NOC-initiated customer analytics and flow accounting in cloud networks. NOC-initiated customer analytics may involve programming customer-specific network analytics processing on specific customer routers and other equipment. In flow accounting in cloud networks, flow-specific statistics are programmed for collection in a large number of virtual network devices (e.g., routers, appliances) in a cloud environment.

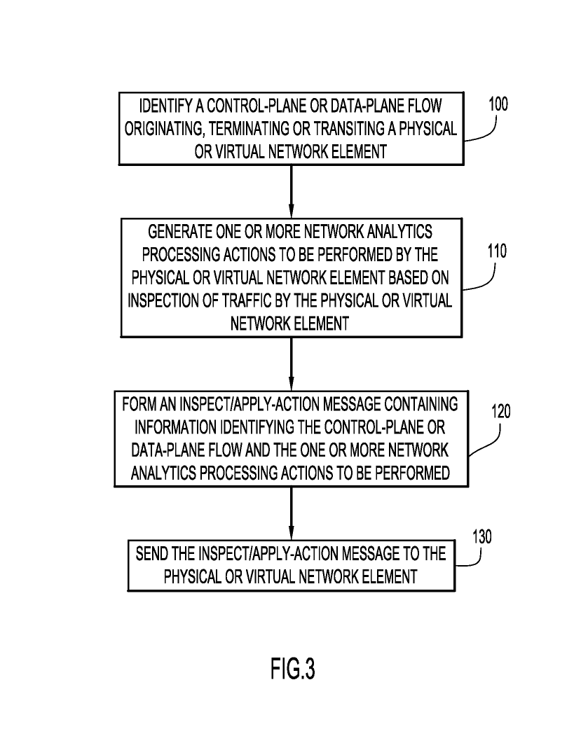

Reference is now made to FIG. 3. FIG. 3 illustrates a flow chart of operations performed by the NAPC 40. At 100, the NAPC 40 identifies a control-plane or data-plane flow originating, terminating or transiting one or more physical or virtual network element. At 110, the NAPC 40 generates one or more NAP actions to be performed by the physical or virtual network element(s) based on inspection of traffic by the physical or virtual network element(s). At 120, the NAPC 40 generates an inspect/apply-action message containing information identifying the control-plane or data-plane flow and the one or more network analytics processing actions to be performed. At 130, the NAPC 40 sends the NAP Inspect/Apply-Action message to the physical or virtual network element(s).

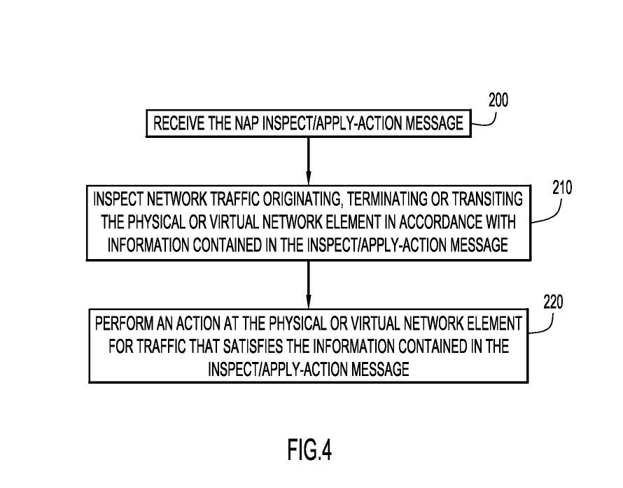

Turning to FIG. 4, a flow chart is shown that generally depicts the operations performed in a physical or virtual network element. At 200, the physical or virtual network element receives the NAP Inspect/Apply-Action message. The appropriate Inspect and Apply-Action functions are installed on the network element by the NAP agent according to the NAP Inspect/Apply-Action message. The inspect/apply-action message may be received at a plurality of physical network elements which are associated with one or more virtual or physical processes, hosts or networks employing said physical network elements for conveying data-plane or control-plane traffic. Conversely, the inspect/apply-action message may be received at a plurality of virtual network elements which are associated with one or more virtual machines configured to provide customer edge connectivity. At 210, the network element inspects network traffic originating, terminating or transiting the physical or virtual network element in accordance with Inspect function installed on the network element. At 220, the network element performs an action for traffic that satisfies the Inspect function according to the Action function installed on the network element.

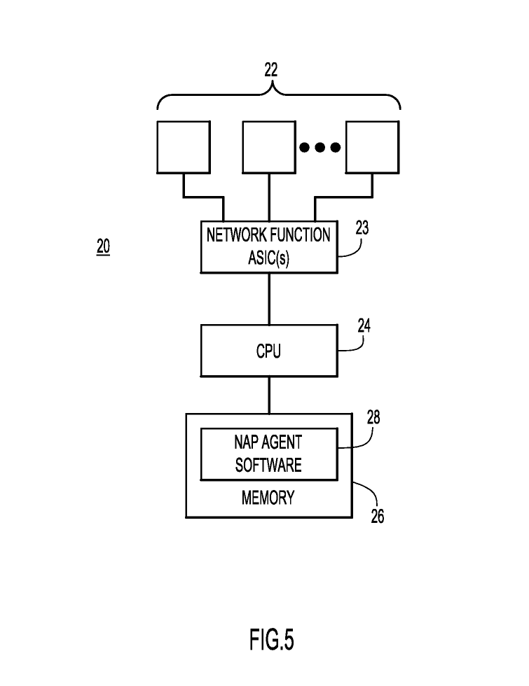

Turning now to FIG. 5, an example block diagram of a network element 20 is shown. The network element 20, which may be physical or virtual, includes a plurality ports 22, one or more network function Application Specific Integrated Circuits (ASICs) 23, a central processing unit (CPU) 24, memory 26 and NAP agent software 28. Packets arrive and depart from the network element 20 via the ports 22. The network function ASICs 23 comprise one or more ASICs configured to perform various network element functions, such as routing, switching, etc. The NAP agent software 28 stored in the memory includes instructions that, when executed by the CPU 24, cause the CPU 24 to perform the NAP agent operations described herein, and in particular shown in the flow chart of FIG. 4. In the case where the network element 20 is a virtual network element, then the CPU 24 would not be present and the functions of the ports 22 and network function ASICs 23 would be performed by one or more virtual machines running on a physical server.

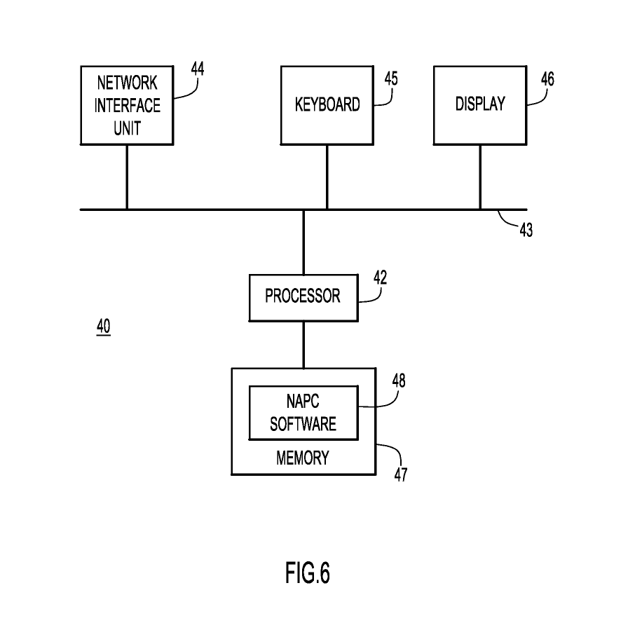

FIG. 6 illustrates an example block diagram of the NAPC 40. The NAPC 40 is a computing apparatus configured to perform NAP functions. In one example, the NAPC 40 includes a processor 42, a bus 43 to which are connected the processor 42 as well as a network interface unit 44 (e.g., a network interface card or multiple network interface cards), an optional keyboard 45 and an optional display 46, as well as a memory 47. The processor 42 is, for example, a microprocessor or microcontroller, or multiple instances of the same. The memory 47 stores instructions for NAPC software 48 that, when executed by the processor 42, cause the processor 42 to perform the operations described herein, for the NAPC 40.

The memory 26 in FIG. 5 and memory 47 in FIG. 6 may comprise read only memory (ROM), random access memory (RAM), magnetic disk storage media devices, optical storage media devices, flash memory devices, electrical, optical, or other physical/tangible memory storage devices. Thus, in general, the memory 26 and memory 47 may comprise one or more tangible (non-transitory) computer readable storage media (e.g., a memory device) encoded with software comprising computer executable instructions and when the software is executed (by a processor or CPU) it is operable to perform the operations described herein.

In summary, a system and corresponding techniques are presented herein to programmatically activate network analytics processing using a simple Inspect/Apply-Action message construct on physical or virtual network elements. These techniques allow for dynamic programmatic configuration of network analytics processing on physical or virtual elements. Different types of applications (or services), such as network management and customer services, can interface to a NAPC for the purpose of programming network analytics processing functions on physical or virtual elements. These techniques are especially suited for automating network analytics processing configuration on a large number of rapidly appearing, moving and disappearing virtual elements typically seen in a virtual network environment.

Thus, a method is provided comprising: identifying a control-plane or data-plane flow originating, terminating or transiting a physical or virtual network element; generating one or more network analytics processing actions to be performed by the physical or virtual network element based on inspection of traffic by the physical or virtual network element; forming an inspect/apply-action message containing information identifying the control-plane or data-plane flow for inspection and the one or more network analytics processing actions to be performed; and sending the inspect/apply-action message to the physical or virtual network element.

Similarly, in software form, one or more computer readable storage media are provided, encoded with software comprising computer executable instructions, and when the software is executed (e.g., by a processor) it is operable to: identify a control-plane or data-plane flow originating, terminating or transiting a physical or virtual network element; generate one or more network analytics processing actions to be performed by the physical or virtual network element based on inspection of traffic by the physical or virtual network element; generate an inspect/apply-action message containing information identifying the control-plane or data-plane flow for inspection and the one or more network analytics processing actions to be performed; and cause the inspect/apply-action message to be sent to the physical or virtual network element.

In addition, an apparatus is provided comprising: a network interface unit configured to enable communications over a network; a memory; a processor coupled to the network interface unit and the memory, the processor being configured to: identify a control-plane or data-plane flow originating, terminating or transiting a physical or virtual network element; generate one or more network analytics processing actions to be performed by the physical or virtual network element based on inspection of traffic by the physical or virtual network element; generate an inspect/apply-action message containing information identifying the control-plane or data-plane flow for inspection and the one or more network analytics processing actions to be performed; and cause the inspect/apply-action message to be sent, via the network interface device, to the physical or virtual network element.

The above description is intended by way of example only.

What is claimed is:

1. A method comprising:
at a controller apparatus, identifying a control-plane or data-plane flow originating, terminating or transiting a physical or virtual network element;
generating one or more network analytics processing actions to be performed by the physical or virtual network element based on inspection of traffic by the physical or virtual network element;
forming an inspect/apply-action message containing information identifying the control-plane or data-plane flow for inspection and the one or more network analytics processing actions to be performed; and
sending the inspect/apply-action message to the physical or virtual network element.

2. The method of claim 1, wherein generating the one or more network analytics processing actions comprises specifying a destination device to which results of the inspection are to be sent.

3. The method of claim 1, wherein sending comprises sending the inspect/apply-action message to a plurality of physical and/or virtual network elements.

4. The method of claim 1, further comprising:
receiving the inspect/apply-action message at the physical or virtual network element;
inspecting network traffic originating, terminating or transiting the physical or virtual network element in accordance with the inspect/apply-action message; and
performing an action at the physical or virtual network element for traffic in accordance with the one or more network analytics processing actions specified in the inspect/apply-action message.

5. The method of claim 1, wherein identifying comprises identifying specific customer network equipment, wherein generating one or more network analytics processing actions to be performed on the specific customer equipment.

6. The method of claim 1, wherein the one or more network processing actions include collection of flow-specific statistics for a plurality of virtual network devices in a cloud environment.

7. One or more computer readable storage media encoded with software comprising computer executable instructions and when the software is executed operable to:
identify a control-plane or data-plane flow originating, terminating or transiting a physical or virtual network element;
generate one or more network analytics processing actions to be performed by the physical or virtual network element based on inspection of traffic by the physical or virtual network element;
generate an inspect/apply-action message containing information identifying the control-plane or data-plane flow for inspection and the one or more network analytics processing actions to be performed; and
cause the inspect/apply-action message to be sent to the physical or virtual network element.

8. The computer readable storage media of claim 7, wherein the instructions operable to generate comprise instructions operable to generate the one or more network analytics processing actions comprises specifying a destination device to which results of the inspection are to be sent.

9. The computer readable storage media of claim 7, wherein the instructions operable to identify comprise instructions operable to identify specific customer network equipment, and the instructions operable to generate comprise instructions operable to generate one or more network analytics processing actions to be performed on the specific customer equipment.

10. The computer readable storage media of claim 7, wherein the one or more network processing actions include collection of flow-specific statistics for a plurality of virtual network devices in a cloud environment.

11. The computer readable storage media of claim 7, wherein the instructions operable to cause the inspect/apply-action message to be sent comprise instructions operable to cause the inspect/apply-action message to be sent to a plurality of physical and/or virtual network elements.

12. An apparatus comprising:
a network interface unit configured to enable communications over a network;
a memory;
a processor coupled to the network interface unit and the memory, the processor configured to:
identify a control-plane or data-plane flow originating, terminating or transiting a physical or virtual network element;
generate one or more network analytics processing actions to be performed by the physical or virtual network element based on inspection of traffic by the physical or virtual network element;
generate an inspect/apply-action message containing information identifying the control-plane or data-plane flow for inspection and the one or more network analytics processing actions to be performed; and
cause the inspect/apply-action message to be sent, via the network interface device, to the physical or virtual network element.

13. The apparatus of claim 12, wherein the processor is configured to generate the one or more network analytics processing actions comprises specifying a destination device to which results of the inspection are to be sent.

14. The apparatus of claim 12, wherein the processor is configured to identify specific customer network equipment, and to generate one or more network analytics processing actions to be performed on the specific customer equipment.

15. The apparatus of claim 12, wherein the processor is configured to generate the one or more network processing actions including a collection of flow-specific statistics for a plurality of virtual network devices in a cloud environment.

16. The apparatus of claim 12, wherein the processor is configured to cause the inspect/apply-action message to be sent to a plurality of physical and/or virtual network elements.

17. A method comprising:
receiving an inspect/apply-action message at the physical or virtual network element, the inspect/apply-action message containing information identifying the control-plane or data-plane flow for inspection and the one or more network analytics processing actions to be performed;
inspecting network traffic originating, terminating or transiting the physical or virtual network element in accordance with the inspect/apply-action message; and
performing an action at the physical or virtual network element for traffic in accordance with the one or more network analytics processing actions specified in the inspect/apply-action message.

18. The method of claim 17, further comprising installing an inspect function and an action function on the physical or virtual network element based on the received inspect/apply-action message.

19. The method of claim 17, further comprising sending results of the one or more network analytics processing actions to a destination device specified in the inspect/apply-action message.

20. The method of claim 17, wherein receiving comprises receiving the inspect/apply-action message at a plurality of virtual network elements which are associated with one or more virtual machines configured to provide customer edge connectivity.

21. The method of claim 17, wherein receiving comprises receiving the inspect/apply-action message at a plurality of physical network elements which are associated with one or more virtual or physical processes, hosts or networks employing said physical network elements for conveying data-plane or control-plane traffic.
